(19) United States
(12) Patent Application Publication
(10) Pub. No.: US 2006/0068294 A1
(43) Pub. Date: Mar. 30, 2006

(54) Lead acid battery with gelled electrolyte contained within compressed absorbent separator mat and method of making the same

(75) Inventors: Stephen L. Mraz, Warrington, PA (US); James D. Dillon III, Conshohocken, PA (US); Sudhan S. Misra, North Wales, PA (US); Terrence M. Noveske, Pipersville, PA (US)

Correspondence Address: HOFFMANN & BARON, LLP, 6900 JERICHO TURNPIKE, SYOSSET, NY, 11791, US

(73) Assignee: C&D Charter Holdings, Inc.

(21) Appl. No.: 10/954,046

(22) Filed: Sep. 29, 2004

(51) Int. Cl. H01M 10/10; H01M 10/04; H01M 2/16

(52) U.S. Cl. 429/302; 29/623.5; 429/247

(57) ABSTRACT

A method for producing a valve-regulated lead acid battery includes the steps of (i) providing a battery comprising a preformed positive electrode plate, a preformed negative electrode plate and a porous separator mat having pores and being compressibly disposed between the electrodes to define a cell assembly, and a container for securably and sealingly holding the cell assembly; (ii) forming a electrolyte mixture comprising an aqueous colloidal dispersion of silica and sulfuric acid that is a precursor to a flowable thixotropic gel; (iii) applying a vacuum to the container; and (iv) introducing a quantity of the gel-precursor electrolyte into the container under a vacuum so that the flowable electrolyte mixture penetrates into the pores of the compressed mat, whereby as the acid absorbs onto the plates, the flowable electrolyte solidifies and forms a thixotropic gel within the pores and around peripheral edges of the mat to surround and seal the cell assembly. A battery produced by these steps include (i) a positive electrode plate; (ii) a negative electrode plate; (iii) an absorbent glass mat compressibly disposed between the electrodes, wherein the glass mat is in substantial contact with both electrodes; and (iv) gelled electrolyte disposed within the pores of the compressed glass mat and around peripheral edges of the glass mat, wherein the gelled electrolyte comprises of an intimate mixture of colloidal alkali metal polysilica having a particle size from about 4 nanometers to about 20 nanometers and sulfuric acid.

### FIELD OF THE INVENTION

The present invention is directed to a lead acid battery that is a hybrid of gelled electrolyte lead acid battery and an absorbent porous mat lead acid battery. More particularly, the present invention is a valve-regulated lead acid battery having gelled electrolyte contained within the pores of porous glass separator mat, which are compressibly disposed between positive and negative electrode-plates.

### BACKGROUND OF THE INVENTION

A lead-acid battery is comprised of one or more each of positive and negative plates that are spaced apart and inter-leafed with a separator between each plate pair, together with an electrolyte constituted from diluted sulfuric acid. When a lead-acid battery is discharged, sponge lead (Pb) at the negative plate and lead dioxide (PbO₂) resident at the positive plate are converted into lead sulfate (PbSO₄). Thus, during discharge the sulfate of the sulfuric acid is absorbed into the electrodes. These reactions are reversed during charge, but a significant amount of secondary reactions also occur, thus requiring overcharge. The reaction at the positive electrode is: 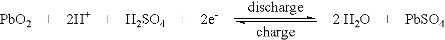
The reaction at the negative electrode is: 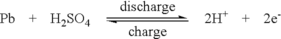
The overall reaction is: 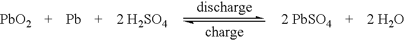
The primary overcharge reaction is the electrolysis of water that produces gaseous oxygen at the positive plate and hydrogen gas at the negative plate. In flooded (or vented) battery designs the oxygen and other gasses escape from the battery resulting in battery maintenance that requires the addition of water. In a valve-regulated lead acid (VRLA) battery the oxygen generated from the electrolysis of water is recombined with the sponge lead at the negative plate thereby suppressing hydrogen evolution, as follows:
2 Pb+O₂+2 H₂SO₄ [symbol] 2 PbSO₄+2 H₂O

Valve-regulated lead acid batteries utilize a sealed cell configuration to avoid the escape of moisture and/or gases. A valve, however, is included for release of gas to avoid possible over pressurization. The VRLA battery avoids the frequent maintenance of adding water of vented or flooded lead acid batteries. A characteristic of many VRLA batteries is the immobilization of the acid electrolyte between the electrodes.

One type of VRLA battery utilizes a gelled electrolyte between the electrodes. The gelled electrolyte generally consists of a mixture of sulfuric acid and fumed silica. The gel immobilizes the free electrolyte or acid between the electrodes. The gel tends to reduce stratification of the acid or migration of the acid toward the bottom of the cell, a concern with tall flooded battery designs. Over time, however, the gel tends to dry out and shrink thereby losing contact with the electrode and adversely affecting performance. This is especially true in motive power applications where voltages and temperatures are not tightly controlled.

Another type of VRLA battery utilizes a porous mat, such as an absorbent glass mat (AGM) for the separator. The porous separator mat is typically made from a nonwoven felt of microfine glass fibers that allow the liquid electrolyte or acid to be absorbed into the pores of the mat and to be somewhat immobilized thereat. For improved contact between the electrode plates and the porous mat, the porous mat may be compressibly disposed between the electrodes. The porous mat, however, often loses compression over time thereby adversely affecting the battery performance.

A hybrid of these two types of VRLA batteries is a battery having a porous mat with liquid electrolyte absorbed into its pores and also having peripheral portions of the porous mat and/or the electrodes surrounded and sealed with a gelled electrolyte. Such encapsulation by the gelled electrolyte helps to diminish water loss from the porous mat. The encapsulation also provides for a larger electrolyte reservoir within the battery. An example of such a battery is disclosed in U.S. Pat. No. 5,376,479 to Gerner, the contents of which are incorporated herein by reference.

Different techniques for sealing peripheral portions of porous mat/electrode assemblies include sequential addition electrolyte and gel-forming components or mixtures. For example, U.S. Pat. No. 5,338,596 to Bechtold et al. describes the addition sulfuric acid without any gelling agent to fill the porous mat with liquid acid and then describes the addition of a silica/sulfuric acid gelling mixture to seal peripheral portions of the cell. U.S. Pat. No. 4,391,036 to Kishimoto et al. describes the addition of sulfuric acid with a low concentration of silica followed by a second addition of sulfuric acid with a high addition of silica to seal peripheral portions of the cell. Such peripheral sealing, however, did not address the concerns of maintaining porous mat and electrode contact over time.

Other patents describe the incorporation of a free space between electrodes and/or the porous mats in a battery design where the free space is filled with gelled electrolyte. For example, U.S. Pat. No. 4,317,872 to Varma describes a battery having its electrodes wrapped with a microfiber mat. The wrapped electrodes are described as being spaced-apart or separated by a separator. A silica/sulfuric electrolyte mixture is described as being added to the battery case, including the free space between wrapped electrodes. U.S. Pat. No. 3,457,112 to Reber describes a lead acid battery having its positive electrode plates covered by a porous mat and having gelled silica/sulfuric acid electrolyte disposed in free spaces between the wrapped positive electrode plates and unwrapped negative electrode plates. In other words, the '112 Patent describes discrete segments spaced-apart electrodes, porous mats and gelled electrolyte. U.S. Pat. No. 3,172,782 to Jache describes positive and negative electrodes being covered by porous fibrous material and being spaced-apart by corrugated spacers. A sulfuric acid/silica gelled electrolyte is described as filling the free spaces between electrodes. WO 03/067684 A2 describes the use of a never dried precipitated silica slurry and sulfuric acid as a gelling mixture. The gelling mixture is placed within the battery including free spaces between the electrodes and porous separator mats. While these patents or publications describe advantages for the use of gelled electrolyte in free spaces between battery electrodes, such gelled filled free spaces increase the overall dimensions of the battery case as compared to batteries not having such free spaces and do not fully address the concern of gel dry out. In addition, they do not address the need for maintaining a compressive force while fully immobilizing the electrolyte.

U.S. Pat. No. 1,583,445 to Collins describes a gelled electrolyte of silicic acid and sulfuric acid having glass wool particles acting as a binder to prevent cracks or fissures being formed in the gelled electrolyte. The glass wool particles may be added into the silicic acid and sulfuric acid or may be placed between the electrodes before the silicic acid and sulfuric acid solution is added to the battery. Such a gelled electrolyte would not be useful in a VRLA battery because the lack of cracks or fissures would prohibit oxygen transfer and thereby prevent or limit oxygen recombination.

Porous separator mats have been described as being formed with a solid gelling agent contained therein. For example, U.S. Pat. No. 5,605,549 to Zucker describes a porous separator pad as being a nonwoven polymeric pad having internal pockets containing powdered acrylic polymer and fumed silica particles. The pad is placed between electrodes within a battery and upon contact with acid the acrylic particles swell causing the pad to expand against the electrodes and the fumed silica forms a gelled electrolyte. U.S. Pat. No. 4,150,199 to Tuphorn describes forming a porous absorbent glass mat for use with a lead acid battery where the mat is described as being a densely compressed compact of fiber glass and fumed silica. The mat is placed between positive and negative electrode plates. Upon the introduction of acid, a gel is described as being formed within the mat. U.S. patent application Publication No. 2002/0192562 to Ferreira et al. describes the embedding of fumed silica particles into a porous mat. The mat may be placed between electrodes, and upon the introduction of sulfuric acid, a gelled electrolyte is described as being formed within the mat. GB 2,383,678 A describes a porous mat being formed from fiber glass fibers and fumed silica particles. The silica-containing mat may be compress between electrodes. Upon the introduction of the acid electrolyte, a gelled electrolyte is described as being formed in the mats. The use of porous mat that are preformed with solid gel-forming agents, however, is expensive and sometimes cumbersome as care must be taken to avoid loss or maldistribution of the powdered gelling agent in the porous mat. Presence of the siliceous materials stiffens the mat and thereby creates difficulties for battery assembly and for establishing the necessary compressive force between the electrode plates.

Despite the efforts of the prior art, there is a need for a lead acid battery having a porous separator mat which can be compressibly disposed between battery electrodes and which can have gelled electrode contained therein.

### SUMMARY OF THE INVENTION

In one aspect of the present invention, a method for making a lead acid battery having gelled electrolyte disposed among the pores of an absorbent mat is provided. The method for producing the inventive lead acid battery includes the steps of:
(i) providing a battery comprising a preformed (i.e., dry charged) positive electrode plate, a preformed negative electrode plate and a porous separator mat having pores and being compressibly disposed between the electrodes to define a cell assembly, and a container for securably and sealingly holding the cell assembly;
(ii) forming a flowable electrolyte mixture comprising an aqueous colloidal dispersion of silica and sulfuric acid that in time forms a thixotropic gel;
(iii) applying a vacuum to the container; and
(iv) introducing a quantity of the gel-precursor electrolyte mixture into the container under a vacuum so that the flowable mixture penetrates into the pores of the compressed mat, whereby even as the acid absorbs onto the plates, the flowable mixture solidifies and forms a gel within the pores and around peripheral edges of the mat to seal the cell assembly.

In this aspect of the present invention, the electrode plates are desirably placed into the container prior to introduction of acid into the container. Further, the preformed positive plate comprises PbO₂, and the preformed negative plate comprises lead metal, Pb, in a non-oxide form.

Desirably, the mat has an uncompressed porosity of about 95% or greater and a compressed porosity of about 90% or greater.

Useful materials for the mat include boron-silicate glass fibers, typically in a nonwoven form. It could be blended with a small quantity of polymeric fibers.

Desirably, the silica is an alkali metal polysilica, preferably, a sodium polysilica. Useful silica particle sizes range from about 4 nanometers to about 20 nanometers.

In another aspect of the present invention, a battery produced by the methods of the present invention is provided.

In another aspect of the present invention, a lead acid battery is provided. The lead acid battery includes (i) a positive electrode plate; (ii) a negative electrode plate; (iii) an absorbent glass mat compressibly disposed between the electrodes, wherein the glass mat is in substantial contact with both electrodes; and (iv) gelled electrolyte disposed within the pores of the compressed glass mat and around peripheral edges of the glass mat, wherein the gelled electrolyte comprises colloidal alkali metal polysilica having a particle size from about 4 nanometers to about 20 nanometers and sulfuric acid. Desirably, the compressed is a boron-silicate glass fiber mat and has a compressed porosity of about 90% or greater.

### BRIEF DESCRIPTION OF THE DRAWINGS

FIG. 1 is a perspective view of an electrode and absorbent mat assembly of the present invention.

FIG. 2 is a side view with a partial cutaway of the assembly of FIG. 1 taken along the 2-2 axis.

FIG. 3 is side view of a portion of the assembly of FIG. 1 taken along the 3-3 axis.

FIG. 4 is an exploded or unassembled view of the portion of the assembly of FIG. 3.

FIG. 5 is a side face view with a partial cutaway of a battery having the electrode and absorbent mat assembly of the present invention.

FIGS. 6 and 7 are graphical depictions of improved performance of the batteries of the present invention having gelled electrolyte with the pores of an absorbent glass mat which is compressibly disposed between electrodes.

### DETAILED DESCRIPTION OF THE INVENTION

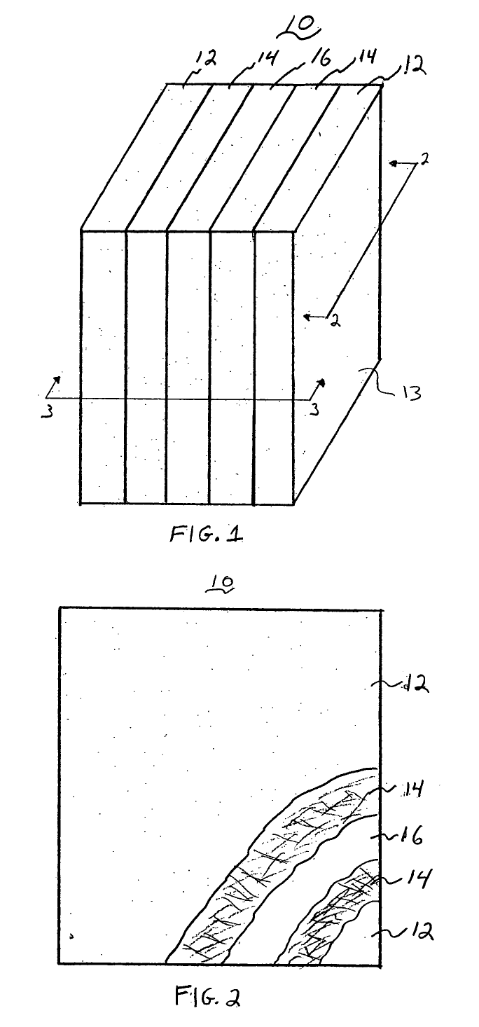

FIG. 1 is a perspective view of a porous separator mat and electrode assembly 10 of the present invention. The assembly 10 includes a negative electrode plate 12 and a positive electrode plate 16 with a porous separator mat 14 disposed therebetween. Although only a limited number of electrodes plates 12, 16 and separator mats 14 are shown in FIG. 1, the present invention is not so limited. Any useful number of electrodes plates 12, 16 and/or mats 14, for example from 1 to 100, may be used to form the assembly 10 of the present invention. Desirably, the terminal plates of the assembly 10 are negative electrode plates 12. Thus, the number of negative electrode plates 12 desirably exceeds the number of positive electrode plates 16 by an integer of one. For example, the assembly 10 of the present invention may contain about 24 negative plates 12 and 23 positive plates 16 with the mats 14 compressibly disposed there between. Although electrode plates 12, 16 are described and depicted as being generally flat and planar in shape, the present invention is not so limited and other electrode shapes, such as, but not limited to, tubular shaped electrodes, may suitably be used.

FIG. 2 is a side elevation view with a partial cutaway of the assembly 10 taken along the 2-2 axis. As depicted in FIGS. 1 and 2, the electrodes 12, 16 and the mats 14 are generally coextensive with one and the other. In other words, the mat 14 substantially covers the face portions 13 of the electrodes 12, 16.

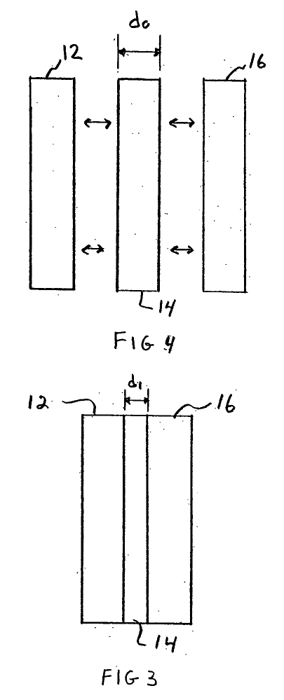

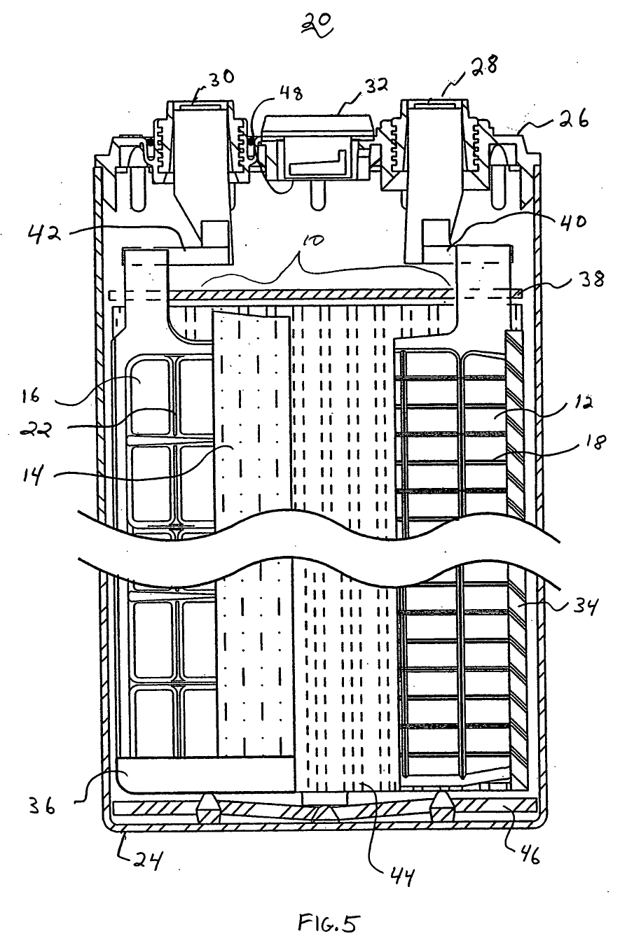

FIG. 3 is a side elevation view of a portion of the assembly 10 taken along the 3-3 axis. The mat 14 is depicted as being compressibly disposed between the negative electrode plate 12 and positive electrode plate 16. As the mat 14 is compressibly disposed between the electrode plates 12, 16, the mat 14 is in substantial contact with the plates 12, 16. Further as depicted in FIG. 3, the compressed mat 14 has a compressed diameter of d₁.

FIG. 4 is an exploded or unassembled view of the portion of the assembly 10 of FIG. 3. The mat 14 in FIG. 4 is depicted as having a thickness of do. This uncompressed or preassembled mat thickness is greater than the compressed thickness, i.e. d₀>d₁ or d₁<d₀. Desirably, the mat 14 is compressed from about 10 percent to about 50 percent in thickness as it is compressibly disposed between the electrode plates 12, 16. More desirably, the mat 14 is compressed from about 20 percent to about 40 percent. Preferably, the mat 14 is compressed from about 25 percent to about 30 percent.

The porous mat 14 is desirably made from nonwoven material. The term “nonwoven” and its variants refer to fibrous materials which are generally melt blown or spun bonded (e.g., extruded onto a moving web on a conveyer belt.); prepared by a wet-laid process (e.g., where a flocculated mixture of fibers is passed through a screen/sieve with the removal of water); or prepared by a dry-laid process such as carding. Nonwoven mats may additionally be bonded by thermal, chemical or mechanical means for improved stiffness.

The fiber diameter of the fibers making the mat 14 may range from about 0.1 micron to 30 microns or more, more desirably between about 0.2 to 2.0 microns. Further, the mat 14 should have as much porosity or void volume as possible. As used herein the term porosity and it variants refer to a ratio of the total void or free volume versus the total apparent volume occupied by the mat, and is expressed as a percentage. The void volume is calculated by difference, knowing the density of the solids that comprise the mat. Desirably, the mat 14 has a porosity of about 95 percent or greater before being compressed. After being compressed, the mat 14 of the present invention still has a high porosity, for example about 90 percent porosity or greater. These porosity values, however, are not limited and mats with other porosity values may suitably be used. For example, mats with a porosity, either compressed or uncompressed, of at least 60% or greater may be used, more desirably at least 80% or greater, and preferably at least 90% or greater.

The porous mat 14 should be able to withstand a harsh chemical environment created by the presence of liquid electrolytes, such as sulfuric acid. Desirably, the mat 14 may be formed from a chemically resistant glass fiber composition, such as borosilicate glass fibers. Certain polymeric materials could replace the glass fibers or be blended with the glass fibers. Suitable polymeric materials for the mats 14 include, but are limited to, polyolefins such as polyethylene, polypropylene, polyisobutylene, and ethylene-alpha-olefin copolymers; acrylic polymers and copolymers such as polyacrylate, polymethylmethacrylate, polyethylacrylate; polyvinyl ethers such as polyvinyl methyl ether; polyacrylonitrile; polyvinyl ketones; polyvinyl aromatics such as polystyrene; polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; natural and synthetic rubbers, including butadiene-styrene copolymers, polyisoprene, synthetic polyisoprene, polybutadiene, butadiene-acrylonitrile copolymers, polychloroprene rubbers, polyisobutylene rubber, ethylene-propylene rubber, ethylene-propylene-diene rubbers, isobutylene-isoprene copolymers, and polyurethane rubbers; polyesters, such as polyethylene terephthalate; polycarbonates; polyimides; and polyethers. Thus, the mat 14 suitably may be a combination of glass fibers and polymeric fibers.

FIG. 5 is a side elevational view with a partial cutaway of battery 20, which is a VRLA battery, of the present invention. The view is a face view of the battery, i.e., facing the faces of the electrodes plates. For simplicity only one negative electrode plate 12, one porous mat 14 and one positive electrode plate 16 are depicted in FIG. 5. Further, the plates 12, 16 and the mat 14 are also in a cutaway face view.

As depicted in FIG. 5, the porous mat and electrode assembly 10 having the electrodes 12, 16 and the porous mat 14 of the resent invention is disposed within a container or jar 24. A cover 26 is sealingly disposed over the container 24. The container 24 and the cover 26 may be made of any suitable material, for example, hard rubber or thermoplastic material. The cover 26 may be adhesively bonded to the container 24 or may be heat bonded. Desirably, the cover 26 and the container 24 are made of the same thermoplastic material, such as polypropylene, which has a low moisture and oxygen transmissivity, and are heat bonded together to form a substantially fluid-tight seal.

The cover 26 also contains a negative post 28, positive post 30 and a relief valve 32. Relief valve 32 is normally closed to prevent the release of moisture and/or oxygen, but may open in the advent of an over pressurization within battery 20. The negative post 28 is electrically connected to the negative electrodes 12 via a negative post strap 40. Similarly, the positive post 30 is electrically connected to the positive electrodes 16 via a positive post strap 42. The negative and positive electrodes 12, 16 have electrode support elements 18, 22, respectively, which support active metal material on the electrodes.

The present invention is not limited to any particular dimensions for the plates 12, 16. Desirably, the plates 12, 16 are thin-walled plates to minimize the overall dimensions of the battery 20. Nonlimiting examples of useful plate thicknesses include negative plates having a thickness of about one half inch or less, for example from about 0.040 inches to about 0.200 inches, and positive plates having a thickness of about one half inch or less, for example from about 0.050 inches to about 0.300 inches. The plates are lead or lead-comprising plates. Desirably, the plates 12, 16 in the assembly 10 are preformed, i.e., are in their active state, and are dry-charged into the container 24. In the preformed or active state the lead in the negative plate 12 is in the form of Pb sponge, and the lead in the positive plate 16 is in the form of PbO₂. Prior to formation the lead in the plates 12, 16 are in the form of lead oxide (PbO).

A Nonlimiting method for pre-forming the lead plates of the present invention includes the steps of:
(i) Placing a suitable number of negative and positive plates, for example 22 positive plates and 23 or 24 negative plates, into a cassette in an alternating, spaced apart orientation;
(ii) Introducing the plates into a sulfuric acid bath having a specific gravity from about 1.010 to about 1.100;
(iii) Soaking the plates in the acid until the acid wets the plates;
(iv) Providing a low current in stepped-up fashion for an extended period of time, typically for 24 to 96 hours, to consume about 150 to 300 ampere-hours per pound of dry active lead oxide;
(v) Placing the plates into a rinse tank with flowing water for several hours to remove the acid within the plates; and
(vi) Placing the plates in an oven with an inert atmosphere, e.g., Nitrogen and CO₂, to dry the plates without oxidizing the negative plates.

The formed plates 12, 16 are then combined with the absorbent porous separator mat 14 to complete the assembly 10. One useful, but non-limiting, method for forming the assembly 10 from preformed plates 12,16 include the steps of:
(i) Wrapping a sheet of mat material around each negative plate and/or positive plate and alternatively placing a sheet of mat material between each plate.

Additional details of such wrapping are disclosed in U.S. Pat. No. 6,667,130 to Misra et al., the contents of which are incorporated herein by reference.
(ii) Compressing the plates so that each separator mat 14 is compressed to about a 20% or greater reduction in thickness. Such compression typically requires substantial pressure or force to be applied that exceeds about 3 to 5 pounds per square inch gauge (psig) force.
(iii) Securing the compressed assembly to maintain its compressed state, while establishing electrical continuity for the individual plate groups typically by applying a negative and a positive strap to complete the assembly; and
(iv) Placing the compressed assembly 10 into the container 24.

After the compressed assembly 10 is disposed within the container 24 and after assembling the other elements of the battery 20 as illustrated in FIG. 5, the cover 26 is secured to the container 24 in a fluid-tight fashion, typically by heat sealing. The battery 20 at this point contains active preformed electrodes 12, 16, and porous mats 14 compressibly disposed between the electrodes 12, 16. The battery 20 does not contain acid electrolyte, i.e., the battery 20 is formed with a preformed, dry-charged electrode/mat assembly 10.

An electrolyte mixture that is the precursor for the thixotropic gel of the present invention, which advantageously comprises an aqueous colloidal dispersion of alkali metal polysilica with sulfuric acid, is added to the sealed battery 20. To introduce the electrolyte mixture into the battery 20, the relief valve 32 is removed to reveal an opening 48 at the top of the cover 26. A nozzle (not shown) is secured to the opening 48. The nozzle has a two-way valve or port for the alternate operations of pulling a vacuum on the battery 20 and subsequently introducing the thixotropic gel. First, gas is evacuated from the battery 20 by pulling a vacuum from about 20 to about 30 inches of mercury (Hg), desirably from about 25 to about 28 inches of Hg. The electrolyte mixture (gel precursor) is then introduced into the battery 20. The moss shield 38 protects the mat 14 and electrode assembly 10 during the introduction of the electrolyte mixture. The use of a vacuum advantageously ensures its penetration into the pores of the compressed mats 14. The vacuum also removes gasses from the cell element, which also aids in the distribution of the gel throughout the pores of the compressed mat 14. The electrolyte mixture may be added in a single step or in several steps. If it is added in several steps, then a vacuum, i.e. 20 to 28 inches of Hg, is pulled on the battery 20 prior to each addition step. Desirably, the electrolyte mixture is introduced from 1 to about 5 steps, preferably about 3 steps.

An importance consideration of the present invention is the flowability of the electrolyte mixture that eventually forms the thixotropic gel within the cell, especially into the pores of the compressed mats 14, and prevention of premature gelling as the dry-charged plates 12, 16 soak up some of the acid from the gelling solution. Desirably, the thixotropic gel of the present invention comprises an aqueous colloidal dispersion of alkali metal polysilica with sulfuric acid. A useful colloidal dispersion is represented by the formula if:
[Y₂O].x[SiO₂].nH₂O,
where Y is an alkali metal, preferably sodium, x ranges from about 20 to about 350, and n is a number of moles of water used to in the colloidal solution. Advantageously, the particle size of the colloidal silica is extremely fine at about 4 to about 20 nanometers (nm), preferably about 10 nm. The thixotropic gel is formed by combining the colloidal polysilica and sulfuric acid. Useful weight ratios of acid to polysilica include from about 2:1 to about 10:1, desirably from about 4:1 to about 6:1, preferably about 4.5:1 to about 5.5:1. Further, the specific gravity of the colloidal polysilica may vary from about 1.1 to about 1.3, preferably about 1.15 to about 1.25. The weight percent polysilica may vary from about 10% by weight to about 40% by weight, preferably about 25% by weight to about 35% by weight. Additional details of useful colloidal polysilicas and additional details of useful thixotropic gel formed therefrom are described in U.S. Pat. No. 4,889,778 to Misra et al., the contents of which is incorporated herein by reference. Useful colloidal polysilicas are commercially available as Nycaol® from Akzo Nobel. Moreover, the specific gravity of the acid may vary from about 1.2 to about 1.45, desirably from about 1.3 to about 1.4. Still further, the resulting specific gravity of the thixotropic gel may vary from about 1.25 to about 1.4, desirably from about 1.28 to about 1.35. The thixotropic gels of the present invention are typically much finer or smaller in silica particle size than mixtures made from fumed silicas. Fumed silicas often have 0.2 to 0.4 micron-sized particles, and such larger sized particles would not adequately penetrate the pores of the compressed mat 14.

VRLA batteries that have compressed AGM mats that are only filled with acid lose compression over time. The loss of compression leads to a loss in battery performance. The loss of compression is believed to be due in part to mechanical forces, such as plate expansion and shrinkage due to the electrode reactions, and the liquid acid acting as a lubricant, which allows fibers to move upon being subjected to the mechanical forces. This results in a less effective contact between the plates and the separator. The gelled electrolyte of the present invention, which is contained within the pores of the compressed mat, substantially prevents such reduction of contact. In other words, the compressed mats of the present invention with gelled electrolyte contained therein have and maintain substantial physical contact with the electrode plates over time.

In one aspect of the present invention, a method for producing a lead acid battery, such as a VRLA battery, includes the steps of:
(i) providing a battery comprising a preformed positive electrode plate, a preformed negative electrode plate and a porous separator mat having pores and being compressibly disposed between the electrodes to define a cell assembly, and a container for securably and sealingly holding the cell assembly;
(ii) forming a flowable electrolyte mixture (that is a precursor to the thixotropic gel) comprising an aqueous colloidal dispersion of silica and sulfuric acid;
(iii) applying a vacuum to the container; and
(iv) introducing a quantity of the electrolyte mixture (gel precursor) into the container under a vacuum so that the flowable electrolyte mixture penetrates into the pores of the compressed mat, whereby as the acid absorbs onto the plates, the flowable electrolyte solidifies and forms a gel within the pores and around peripheral edges of the mat to surround and seal the cell assembly.

In another aspect of the present invention, a lead acid battery, such as a VRLA, battery is provided. The battery includes:
(i) at least one positive electrode plate;
(ii) at least one negative electrode plate;
(iii) an absorbent glass mat compressibly disposed between the electrodes, wherein the glass mat is in substantial contact with both electrodes; and
(iv) a thixotropic gelled electrolyte disposed within the pores of the compressed glass mat and around peripheral edges of the glass mat, wherein the gelled electrolyte comprises colloidal alkali metal polysilica having a particle size from about 4 nanometers to about 20 nanometers and sulfuric acid.

The following non-limiting examples are intended to further illustrate the present invention.

### EXAMPLES

### Example 1

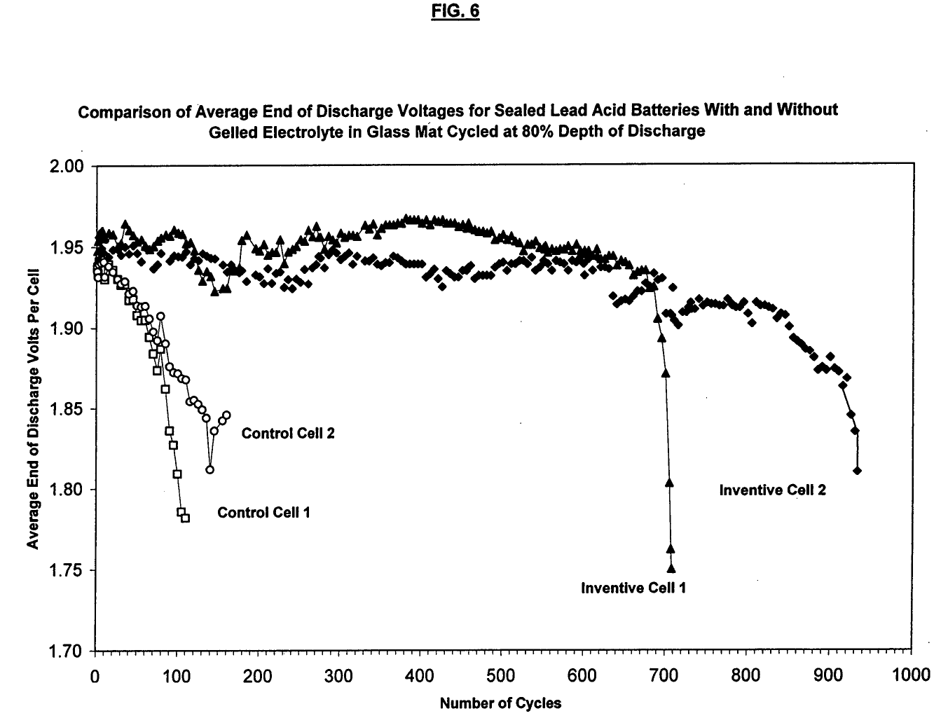

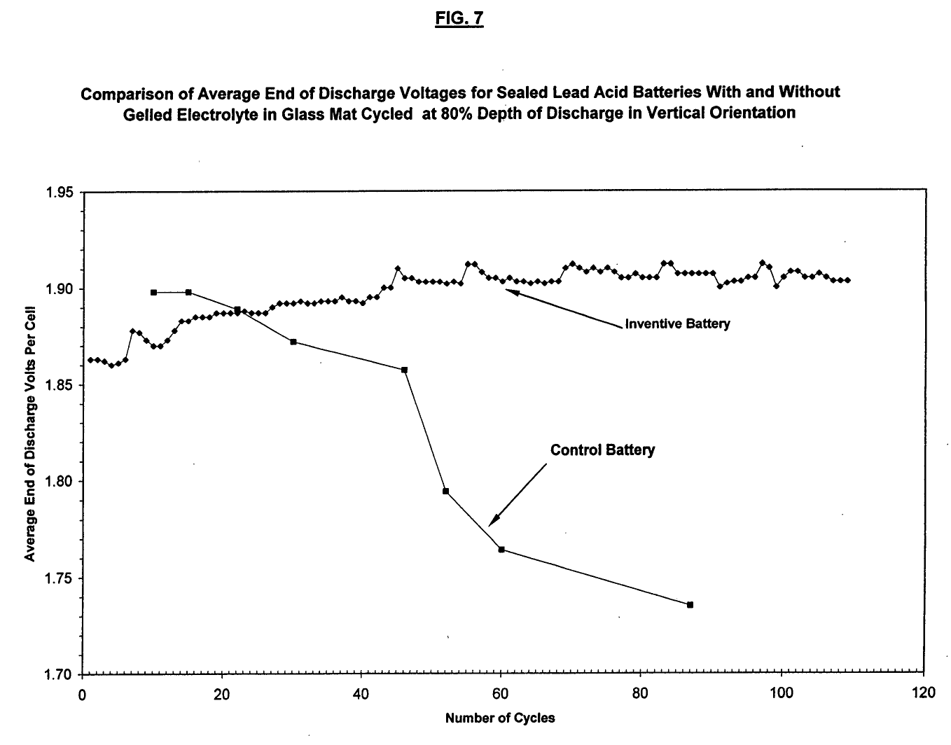

Cells shown in FIG. 6 consisted of two different groups of cells. Control cells 1 and 2 both consisted of cells manufactured with tank formed plates that were dry charged, filled with only acid and activated (charged), then cycled in the vertical position. Control cells I and 2 had the porous mats filled with acid and not with the electrolyte contained in the inventive cells. The inventive cells 1 and 2 had mats filled with a gelled electrolyte according to the present invention. Both the control and inventive cells were cycled in vertical orientation rather than lying down. End of discharge voltages for both groups of cells were measured. Control cells 1 and 2 declined in discharge voltages from about 100 to about 200 cycles. The inventive cells had superior performance as exhibiting no decline in end of discharge voltage over the same number of cycles and only had noticeably decline in end of discharge voltage after about 700 to about 900 cycles.

In order to determine the distribution of colloidal polysilica within the glass mat structure several inventive cells were made from cells with dry charged plates. The positive plates were 6″×19″×0.250″ and the negative plates were 6″×19″×0.180″. An inventive cell was taken apart after filling and charging. A number of sheets of glass mat were removed from electrodes (each sheet of glass was approximately sized at 6 in width×20 in length). The samples of glass mat were located in the middle as well as outside locations within the plate elements. Small rectangular samples of glass mat were cut from the top, middle and bottom portions of the glass mat, that were removed from the inventive cell. Each of the glass mat samples cut into small rectangular pieces were first weighed and then placed into a vented muffle furnace at approximately 800 C for 1 hour. At this temperature, all acid and residual moisture that had been in the sample evaporated. Additional small samples were made from glass mat samples not exposed to either acid or silica. These samples were also weighed before and after being subjected to the same treatment in the muffle furnace. The weight to the blank sample was subtracted from the weight of the sample piece of glass that had been in the inventive cell.

The results from the weight differential between the blank samples and samples from the inventive cell indicated that there was the presence of silica throughout the entire glass mat sample that had been removed from the inventive cell.

### Example 2

Cells were formed with the plates and mats of example 1. FIG. 7 shows the performance for two different types of sealed motive, 6 cell batteries. The control battery consists of jar formed positive and negative electrodes with glass mat separators filled only with electrolyte and not with the electrolyte and colloidal polysilica mixture. The second battery consists of inventive cells. Both batteries were cycled in the vertical orientation. The inventive cells show far superior performance while the control cells decline in capacity in less than 100 cycles, primarily due to severe electrolyte stratification.

Various changes and modifications can be made to the present invention. It is intended that all such changes and modifications come within the scope of the invention as set forth in the following claims.

What is claimed is:

1. A method for producing a lead acid battery comprising:
providing a battery comprising a preformed positive electrode plate, a preformed negative electrode plate and a porous separator mat having pores and being compressibly disposed between the electrodes to define a cell assembly, and a container for securably and sealingly holding the cell assembly;
forming a flowable electrolyte mixture that is a precursor to a thixotropic gel, comprising an intimate mixture of aqueous colloidal dispersion of silica and sulfuric acid;
applying a vacuum to the container; and
introducing a quantity of the gel-precursor electrolyte mixture into the container under a vacuum so that the flowable electrolyte mixture penetrates into the pores of the compressed mat, whereby as the acid absorbs onto the plates, the flowable electrolyte solidifies and forms a thixotropic gel within the pores and around peripheral edges of the mat to surround and seal the cell assembly.

2. The method of claim 1, wherein the electrode plates are placed into the container prior to introduction of acid into the container.

3. The method of claim 1, wherein the preformed positive plate comprises PbO₂.

4. The method of claim 1, wherein the preformed negative plate comprises lead metal, Pb, in a non-oxide form.

5. The method of claim 1, wherein the mat has an uncompressed porosity of about 95% or greater.

6. The method of claim 1, wherein the mat has a compressed porosity of about 90% or greater.

7. The method of claim 1, wherein the mat is a boron-silicate glass fiber mat, optionally mixed with a small quantity of an acid resistant polymer fiber.

8. The method of claim 1, wherein the silica is an alkali metal polysilica.

9. The method of claim 1, wherein the silica is a sodium polysilica.

10. The method of claim 1, wherein the silica has a particle size from about 4 nanometers to about 20 nanometers.

11. A battery formed by the method of claim 1.

12. A lead acid battery comprising:
at least one positive electrode plate;
at least one negative electrode plate;
an absorbent glass mat compressibly disposed between the electrodes, wherein the glass mat is in substantial contact with both electrodes;
a thixotropic gelled electrolyte disposed within the pores of the compressed glass mat and around peripheral edges of the glass mat, wherein the gelled electrolyte comprises colloidal alkali metal polysilica having a particle size from about 4 nanometers to about 20 nanometers and sulfuric acid.

13. The battery of claim 12, wherein the compressed mat has a porosity has a compressed porosity of about 90% or greater.

14. The battery of claim 12, wherein the compressed mat is a boron-silicate glass fiber mat.
